(19) United States
(12) Patent Application Publication
(10) Pub. No.: US 2007/0243100 A1
(43) Pub. Date: Oct. 18, 2007

(54) Voc Removal Method From Voc Impregnated Materials

(75) Inventors: Hikoo Miyauchi, Tokyo (JP); Masahiro Miyauchi, Tokyo (JP)

Correspondence Address: JORDAN AND HAMBURG LLP, 122 EAST 42ND STREET, SUITE 4000, NEW YORK, NY, 10168, US

(73) Assignee: DYNA-AIR INCORPORATED, Chiyoda-ku, Tokyo (JP)

(21) Appl. No.: 11/662,908

(22) PCT Filed: Jun. 20, 2005
(86) PCT No.: PCT/JP05/11282

§ 371 Date: Mar. 15, 2007

(30) Foreign Application Priority Data
Sep. 21, 2004 (JP) 2004-273707

(51) Int. Cl. B01D 43/00; F24F 3/14; F24F 3/16

(52) U.S. Cl. 422/5

(57) ABSTRACT

A problem is to carry out the removal of VOC and odor from VOC impregnated materials existing in a processed space without damaging interior materials and installed objects safely and with a low cost by controlling the humidity. The means comprise a humidification process wherein the inside of a processed space from which VOC should be eliminated is warmed to a high humidity within a range not being saturated, and hydrate complexes are formed between VOC absorbed/impregnated at impregnated materials and vapor-phase water molecules generated; and the second process wherein the VOC hydrate complexes formed inside VOC impregnated materials on said humidification process are radiated from the VOC impregnated materials into the processed space by lowing the humidity.

### TECHNICAL FIELD OF THE INVENTION

This invention relates to a method removing volatile organic compounds (VOC) impregnated in construction materials or others.

### BACKGROUND OF THE INVENTION

Recently, there have been many reports about residents who complain of irritation in the throat and eyes and poor physical conditions such as dizziness and headache immediately after a house or building was built newly or rebuilt because of VOC contamination of the indoor air.

The symptoms are various and unknown aspects including a mechanism of the occurrence of the symptoms remain. Besides those, because various complex factors are assumed, the condition is called sick-house (indoor air contamination) syndrome. Formaldehyde which is highly volatile and strongly toxic was restricted first in 1997. Subsequently, in 2000, restricted chemicals increased to eight, including other seven chemicals; toluene, xylene, paradichlorobenzenem, ethylbenzene, styrene, di-n-butyl phtalate, and chlorpyrifos. At the same time, to restrict chemicals by total emission level, a tentative goal level of total VOC (TVOC) was set at 400μg/m³ or less. In 2001, tetradecane, phtalate-2-diethyl hexyl and diazinon were added. Moreover, in 2002, acetaldehyde and fenobucarb were added. And, indicator levels of the indoor concentrations for these chemicals were determined by Ministry Of Labor And Welfare.

Conventional strategies to reduce the concentrations of the basic chemicals in indoor air include ventilation, use of absorbing agents (patent reference 1), use of deodorant devices, heating (bake-out method), ozone spray, application of preventive agents and others.

These conventional methods are roughly divided into those promoting or preventing the emission from interior materials containing VOC and odor, and others removing VOC and odor in an internally processed space. Representative methods are heating (60° C. or higher) in the former and ventilation in the latter (non-patent reference 1).

As said bake-out methods, those which have been already proposed include VOC outdoor exhaust and removal methods comprising a warming process of the indoor temperature in which the radiation of VOC in a room is forced by increasing the room temperature and a removal process of indoor VOC by air cleaner and/or deodorizer (patent reference 2).

More specifically, based on this patent reference 2, the worming process of the indoor temperature to force the radiation of VOC in the room by increasing the room temperature with ordinary indoor heaters is set at 30˜40° C. or higher and the room is warmed for 0.1˜5 hours or longer. Under the condition to increase the room temperature, when the room humidity is increased by humidifier or others, VOC which are soluble in drops of water in air are captured, causing to increase the radiation level of VOC from housing materials or others. VOC radiated by force are exhausted through windows or other opened. Following it, using a dehumidifier, the room is dehumidified to eliminate the moisture entering from the outside of the room or others.

The ventilation method is a method to replace indoor air with outside air.
There was an apparatus called solvent-concentrate rotor in which VOC are absorbed and concentrated by passing a processed air containing VOC or others through the rotor (filter) with silicagel, zeolite and active carbon.
Patent reference 1: Japanese Provisional Publication No.H10-218702
Patent reference 2: Japanese Provisional Publication No.2001-193974
Non-patent reference 1: Atsushi Nishino et al.; [VOC countermeasures] NTS Publication Co. 1998

### DISCLOSURE OF THE INVENTION

Problem to Be Solved by the Invention

In said warming method, interior materials, installed objects, and others may deteriorate, and particularly, warming processing under a condition in which materials, objects or others are installed is not preferable.

According to the method of the patent reference 2, the test results were written as follows:
(1) When the baked out 1 (warming+circulation of indoor air+forced exhaust) was repeated with 10 cycles, the TVOC decreased, but the formaldehyde level increased.
(2) When the baked out 1 was repeated with five cycles, both the TVOC and formaldehyde level increased.
(3) When the backed out 2 (warming- warming+circulation of indoor air+forced exhaust) was repeated with 10 cycles, the TVOC increased, but the formaldehyde level decreased.

As for these test results, according to the description of the patent reference 2, although a detailed mechanism of said (2) is unknown, a reason for the increase is speculated because VOC released may remain inside the room in cases of insufficient cycles. As for said (3), it is inferred because formaldehyde produced due to the warming may dissolve in drops of water produced inside the room by humidifying, be captured and then eliminated. However, the phenomenon of increased TVOC has not been described at all.

Problems by the method described in the patent reference 2 are as follows:

First, because the humidification by humidifier is conducted by spraying water particles, under a condition of liquid phase, in a room, VOC may dissolve in drops of water adhering to the surfaces of housing materials or others and be captured. However, the VOC level decreases only slightly and its primary removal effect cannot be demonstrated. VOC dissolving in drops of water and being captured are limited to hydrophilic substances, but the effect on hydrophobic substances is absent. A reason why the effect doesn't appear even after completion of said test is speculated due to the above described fact.

Secondly, because the humidification by said method is conducted by humidifier applying the variation in saturated humidity in accordance with the variation in indoor temperature, it is impossible to eliminate VOC inside housing materials or others.

Thirdly, even though it is an exhaust by force, only VOC on the surfaces of housing materials are exhausted, but inner VOC cannot be removed.

Said ventilation method is the simplest method and is effective to eliminate VOC released to air within an internally processed space. However, because the radiation of VOC from interior materials is not promoted, it is necessary to conduct the ventilation processing for its natural radiation continuously over a long period and such a large amount of ventilation becomes a great load on air conditioning.

As for agent-use method, it was likely to highly cost for the agents in any processing case and it was difficult to cope with continuous release of VOC and odor. At places where VOC and odor occurred continuously, loss of heat with a large amount of ventilation was so great that it was difficult to introduce air conditioners.

As for said solvent-concentrate rotor, in cases of the rotors using silicagel or zeolite, the utilized rotor could be reused by processing at a high temperature (150° C. or higher) and eliminating absorbed VOC by re-volatilizing or thermal-decomposing them. However, there was a problem that the rotor was deteriorated so severely due to the high temperature at the processing for reuse that its lifetime was short in comparison with the cost. Because rotors using active carbons with a relatively cheaper cost cannot be processed at a high temperature as those with silicagel or zeolite can, the complete reuse of them was difficult, which was a problem.

The object of the present invention is to carry out the removal processing of VOC and odor without damaging interior materials and installed materials safely and with a low cost in a short period.

Means for Solving Problem

The present invention is a VOC removal process from VOC impregnated materials, wherein an atmosphere where VOC impregnated materials radiating VOC gradually with odor exist is humidified to a high humidity level of a vapor phase condition to make water molecules of the vapor phase condition infiltrate into the insides of the VOC impregnated materials, which results in formation of VOC hydrate complexes between the internal VOC and water molecules to reduce the humidity in the atmosphere, consequently causing to radiate said VOC hydrate complexes from the VOC impregnated materials to the atmosphere; and moreover, the atmosphere is dehumidified to dissociate the VOC hydrate complexes radiated into the atmosphere to VOC and water and the VOC are captured and collected at desiccant by furthermore dehumidification.

Effects of the Invention

In the present invention, water molecules of vapor phase condition infiltrate into the insides of VOC impregnated materials by humidifying the atmosphere to a high humidity level of a vapor phase condition to form VOC hydrate complexes and the VOC hydrate complexes are radiated from the VOC impregnated materials by dehumidification, consequently causing to eliminate VOC from the insides of the VOC impregnated materials.

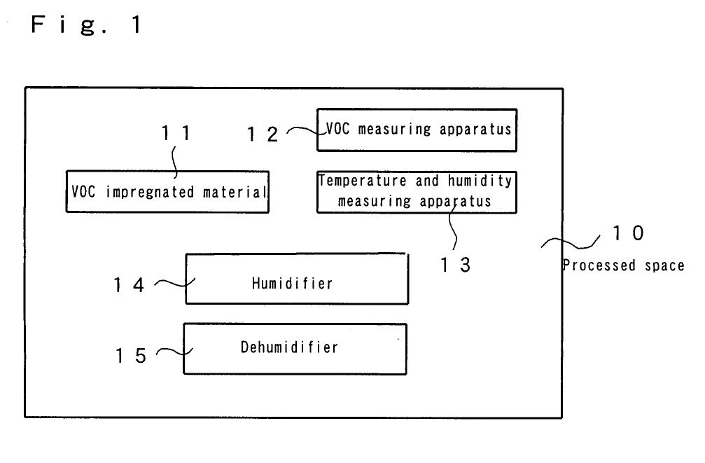

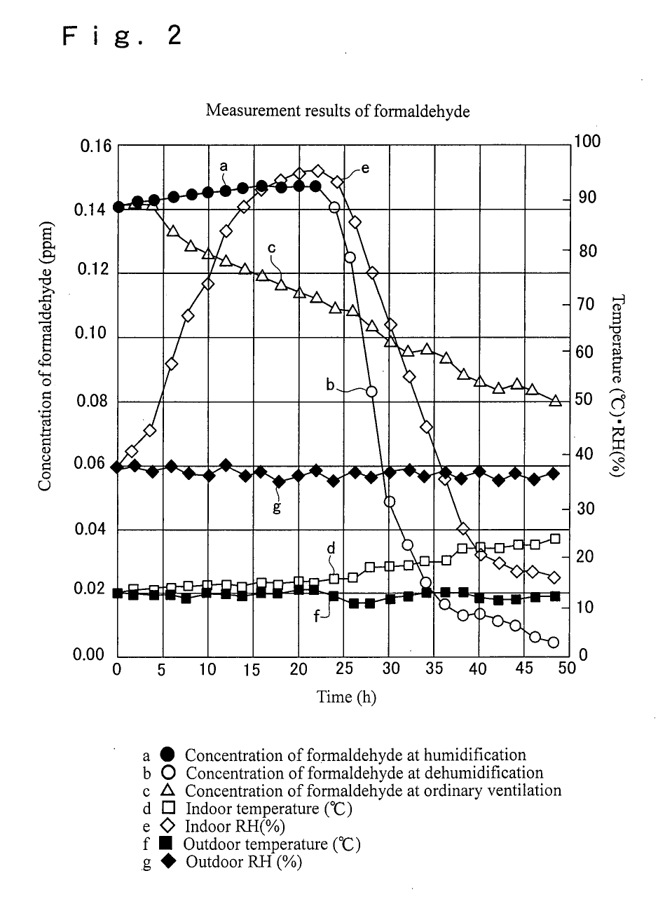

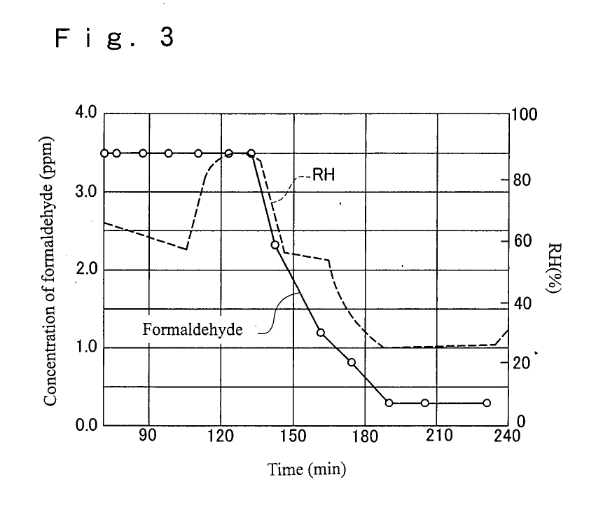

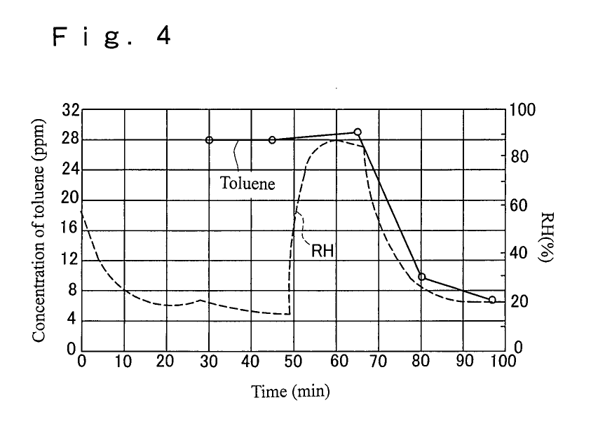

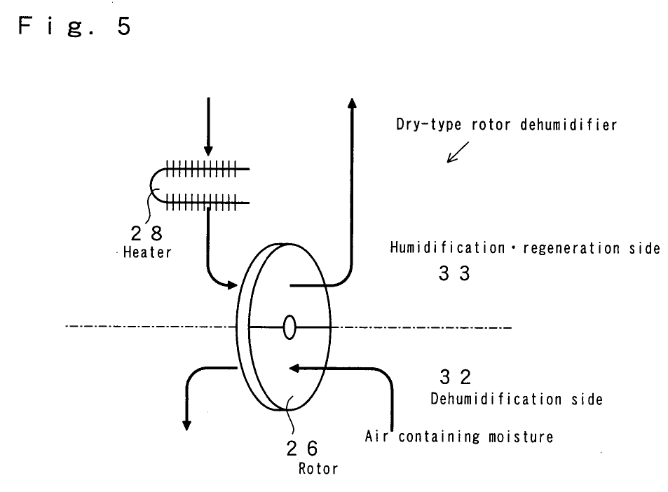

### BRIEF DESCRIPTION OF THE DRAWINGS

[FIG. 1] is a schematic diagram of Embodiment 1 on a VOC removal process of the present invention and the apparatus.

[FIG. 2] is a property figure of the measurement results of formaldehyde on the VOC removal process of the invention and the apparatus.

[FIG. 3] is a figure of measurement results of formaldehyde on the VOC removal process of the invention and the apparatus.

[FIG. 4] is a figure of measurement results of toluene on the VOC removal process of the invention and the apparatus.

[FIG. 5] is a schematic diagram of dry rotor type dehumidifier.

### DESCRIPTION OF REFERENCE NUMERALS

10—Processed space, 11—VOC impregnated material, 12—VOC measuring apparatus, 13—Temperature/humidity measuring apparatus, 14—humidifier, 15—dehumidifier

Best Mode for Carrying Out the Invention

In the present invention, vapor-phase water molecules filtrate into the insides of VOC impregnated materials by humidifying an atmosphere containing VOC to a high humidity of a vapor-phase condition to form VOC hydrate complexes between the filtrated water molecules and the impregnated VOC and then to reduce the humidity in the atmosphere, consequently causing to radiate the hydrate complexes from the VOC impregnated materials.

Moreover, the humidity in the atmosphere is decreased to dissociate the radiated VOC hydrate complex to water and VOC and the VOC are captured and collected at desiccant.

Before embodiments of the present invention are described, the formation of the hydrate complex between water molecules and VOC when the atmosphere is humidified to a high humidity of a vapor-phase condition is described briefly.
(1) In case of hydrophobic VOC; Hydrophobic VOC such as benzene, toluene and xylene have a so weak affinity with water that water molecules and the hydrophobic VOC don't combine directly by hydrogen bonding and by intermolecular forces. Water molecules combine with adjacent water molecules with a strong bonding strength and water's hydrogen bonds are formed in a manner that VOC molecules are surrounded. The VOC behave like a mass of molecules concentrating peripheral water molecules. In this specification, such a condition is called hydrophobic VOC hydrate complex. The number of peripheral water molecules is speculated to be individually specific, depending on VOC's physical properties. From behaviors at the molecular level, it is inferred to be a phenomenon similar to azeotrope.
(2) In case of hydrophilic VOC;

Hydrophilic VOC such as formaldehyde, acetaldehyde, and ammonium have so high hydrophilic group that water molecules and the hydrophilic groups combine directly by hydrogen bonding. Water molecules with a strong bonding strength combine each other peripherally by hydrogen bonding. Consequently, hydrogen bonds among water molecules surrounding VOC molecules are formed similarly to (1), but only the peripheral parts of hydrophilic groups are different in the structure. In this specification, this is called hydrophilic VOC hydrate complex.

In this specification, the molecules with linkage between VOC and water molecules surrounding the VOC as in (1) and (2) described above are called VOC hydrate complex as a generic name. The VOC hydrate complexes are inferred to be produced at a high level under a condition of a high water vapor pressure, namely a high absolute humidity. Thus, first, the humidification to produce the VOC hydrate complexes is necessary to remove VOC. Because the humidification aims at increase of the absolute humidity, maintaining not only the relative humidity at a high level, but also the atmospheric temperature to some extent enables to increase the saturation point and then the absolute humidity, which results in higher VOC removal effect.

Next, a phenomenon of VOC impregnated materials occurring on the humidification process is described from surface-chemical viewpoints.

Although VOC in VOC impregnated materials such as housing materials or others are fixed by intermolecular force, the bond by intermolecular force is so weaker than hydrogen bonding or ion bonding that in ordinary atmosphere where VOC impregnated materials are present, VOC are radiated gradually by volatility of VOC itself. This gradual radiation causes a condition that VOC's odor from housing materials and furniture cannot disappear easily.

Water molecules of a vapor-phase condition under a high humidity form hydrate complexes with VOC floating in a processed space as described previously, and also infiltrate into VOC impregnated materials to form hydrate complexes with the inner VOC. Behaviors of the VOC forming the hydrate complex are controlled by behaviors of water molecules. The number of water molecules infiltrating into the insides of VOC impregnated materials is proportional to the water vapor pressure of the atmosphere. Thus, under a higher atmospheric absolute humidity (water-vapor pressure), the number of water molecules becomes larger, which facilitates to form the VOC hydrate complexes in the VOC impregnated materials.

Under an equilibrium condition of the water vapor pressures in the atmosphere and VOC impregnated materials, the water molecules inside the VOC impregnated materials and the VOC hydrate complexes repeat the radiation and absorption at the same time and maintain an equilibrium. However, at the beginning of the humidification, because the concentration of VOC hydrate complexes at the early stage of the equilibrium is higher in VOC impregnated materials than in the atmosphere, depending on the performance ability of humidifier, it is likely that more VOC hydrate complexes are radiated from the VOC impregnated materials.

Because even when the humidity in the atmosphere increases, sufficient water molecules that immediately contribute for equilibrium of the water vapor pressure don't always infiltrate into VOC impregnated materials, it is necessary to set a sufficient time for the humidification process. For example, while such consideration is not necessary in case that it takes long hours such as 24 hours to reach a planned humidity, when the humidity is increased rapidly by high-performance humidifier, a sufficient ageing is necessary before the dehumidification process.

### EMBODIMENT 1

Embodiment 1 of the present invention is described, based on the drawing as follows:

FIG. 1 shows the embodiment 1 of the invention, wherein 10 is a processed space where VOC-impregnated materials such as housing materials impregnated with VOC or others exist and a humidifier 14 and a dehumidifier 15 are installed. Although the humidifier 14 and the dehumidifier 15 are installed inside the processed space 10, they may be installed outside the processed space by connecting them with ducts or others.

As for said humidifier 14, although any type of humidifier is usable basically, the effect of the present invention becomes extremely low with a humidifier using an ultrasonic transducer, atomizing humidifier or others. Its reasons are considered because in these types of humidifiers, only drops of water of liquid-phase condition are sprayed in the air and liquid-phase water have a so low vapor pressure that hydrate complexes with VOC are not formed; and moreover, the drops are so extremely larger than molecular level of water that although the drops may adhere to the surfaces of housing materials and permeate into the shallow depth, it doesn't occur at a high rate for the drops to infiltrate into the inside, with being coupled with its low activity, then to form hydrate complexes with VOC and finally to escape from the materials.

Therefore, as for the humidifier, it is preferable to include a humidifier such as a heater 28 or others or use a steam humidification. The humidification enables to radiate vapor-phase water to increase the vapor pressure, which leads the water molecules of a high vapor condition to infiltrate into the inside of the VOC impregnated material 11 and then form VOC hydrate complexes.

As for said dehumidifier 15, a wet dehumidifier applying a hygroscopic property of liquid desiccant such as a high concentration of sodium chloride, triethylene glycol or others is used. Since such wet dehumidifiers are not new apparatuses, the detailed descriptions are omitted here.

Next, a method to capture and collect VOC and a removal method of VOC from the VOC impregnated material 11, using above said apparatus, are described.

First, as the first process, the processed space 10 is humidified to a high humidity of a vapor-phase condition within a range not reaching the saturation. Because an indoor RH is usually 20˜70%, specifically, a preferable high humidity ranges 80˜95%. On the humidification process, as described above, a sufficient time is set.

The first process leads to form hydrate complexes with VOC floating in the atmosphere in the processed space 10, and for vapor-phase water molecules to infiltrate into the VOC impregnated material 11 and form hydrate complexes with VOC absorbed inside it.

When a sufficient time has passed to reach an equilibrium between the atmosphere of the processed space 10 and the VOC impregnated material 11, as the second process, the atmosphere inside the processed space is dehumidified by the dehumidifier 15. At the beginning of the second process, as the first step, mainly, water floating in the atmosphere of the processed space is captured and collected at the desiccant of the dehumidifier 15 for dehumidification. At the first step, VOC floating in the atmosphere of the processed space 10 form hydrate complexes and are unlikely to be captured. Then, as the humidity in the atmosphere decreases, the equilibrium of the water vapor pressure between the atmosphere of the processed space 10 and the inside of the VOC impregnated material collapses and the vapor pressure inside the VOC impregnated material 11 becomes higher. Then, as the second step, water molecules and VOC hydrate complexes are radiated from the VOC impregnated material 11. Even at the second step, VOC are not captured easily. Moreover, when the humidity lowers, as the third step, VOC hydrate complexes floating in the atmosphere of the processed space 10 begin to dissociate to water and VOC and the dissociated water are captured and collected at the dehumidifier 15. When the humidity lowers furthermore, as the fourth step, VOC are captured and collected at the dehumidifier and then eliminated.

In this description of the second process, for convenience' sake, the process is divided into the first˜fourth steps and it is explained that VOC is captured and collected at the dehumidifier 15 in the fourth step. However, the capture and collection of water and VOC is a matter of thermal statistical mechanical probability and the capture of VOC is inferred to occur gradually from the first step, although it may be slight. Particularly, the possibility is high that hydrophilic VOC may be captured at the desiccant while remaining as the hydrate complexes, and the results of an experimental example (formaldehyde) described later indicate it.

On the second process, even when the humidity of the atmosphere in the processed space 10 lowers, only the water vapor pressure becomes an equilibrium between water and VOC hydrate complexes, but the water and the VOC hydrate complexes are not radiated from the VOC impregnated material 11 immediately. Thus, on the dehumidification process, the dehumidification should not be stopped even when the humidity of the atmosphere in the processed space 10 lowers, and a sufficient time after the humidity lowered sufficiently is set. The time for the lower limit asymptotic condition of the humidity is set at once˜twice of the humidification time.

As such, the humidification process and the dehumidification process are made one cycle and when a reduction of the concentration is needed, this cycle is repeated.

To verify the effect of above said embodiment 1, an experiment was conducted with the VOC impregnated material 11 contained in the processed space 10 of 2.7 m×2.7 m×2.4 m. In the processed space 10, the humidifier 14, dehumidifier 15, a VOC measuring apparatus 12, and a temperature and humidity measuring apparatus 13 are placed.

As for said VOC impregnated material 11, formaldehyde is applied to a veneer and the veneer is dried with outside air for two days for use as its sample. The two-day dry with outside air was done with sunlight during day and storing at the laboratory during night when the weather was such other than raining. At raining, the sample was stored at the laboratory.

In this experiment, the measurements were conducted on five processes.
[2] Preprocessing measurement: After the processed space 10 is closed for eight hours, the VOC concentration is measured.
[2] Humidification process: As the first step described previously, the inside of the processed space 10 is humidified to RH95% vapor-phase condition and this condition is maintained for 24 hours after the humidification is initiated.
[3] Dehumidification process: As the second step described previously, the inside of the processed space 10 is dehumidified by dehumidifier 15 for 24 hours.
[4] Ventilation before measurement: The ventilation is conducted sufficiently to replace air in the processed space 10 with outside air completely.
[5] Measurement after processing: The VOC concentration is measured as it is noted that the temperature, closed time and others [1] become identical to those before processing. When differences are present, such as in temperature or others, correction of the temperature or others is conducted when necessary.

As shown in FIG. 2, at the step of [1] measurement before processing:

The concentration of formaldehyde (the property curve a): 0.14 ppm (the concentration indicator level set by Ministry Of Labor And Welfare=0.08 ppm)
Relative humidity RH of the processed space (the property curve e): about 37%
Relative humidity RH of outside air (the property curve g): about 37%
Temperature of the processed space (the property curve d): about 12° C.
Temperature of outside air (the property curve f): about 12° C.

On the humidification process, the RH in the processed space 10, as shown in the property curve e, was about 38% at the beginning, and increased to about 95% after 24 hours. The RH of outside air, as shown in the property curve g, was about 38% with almost no change. The temperature in the processed space 10, as shown in the property curve d, was about 12° C. at the beginning, and increased to about 15° C. after 24 hours. The temperature of outside air, as shown in the property curve, hardly changed, being about 12° C.

The concentration of formaldehyde tends to increase for about 16 hours after initiation of the humidification, although it's slight, as shown in the property curve a. This indicates that vapor-phase water molecules form hydrate complexes with VOC existing on the surface of the VOC impregnated material 11 and inside it and the complexes are radiated into the processed space 10. The concentration doesn't increase from around soon after 16 hours. This finding is considered because the number of VOC hydrate complexes radiating from the VOC impregnated material 11 to the atmosphere and the number of VOC hydrate complexes adhering to the VOC impregnated material 11 have reached an equilibrium. Thus, even if the first process is ended at around that time, it is inferred that the effect of the invention may not decrease so greatly.

On [3] the dehumidification process, the RH in the processed space 10, as shown in the property curve e, decreased from about 95% at the humidification on the first process to about 15% over 24 hours after initiation of the dehumidification, and the concentration of formaldehyde, as shown in the property curve a, decreased markedly from 0.143 ppm to 0.005 ppm or less. As a characteristic at that time, the RH in the processed space and the concentration of formaldehyde decrease as drawing a roughly similar curve. This is speculated because in case that most of formaldehyde in the atmosphere form VOC hydrate complexes and desiccant agent has a reserve capacity for absorption, VOC hydrate complexes themselves are captured at the desiccant.

The RH of outdoor air, as shown in the property curve g, hardly changed, being about 38%. The temperature in the processed space 10, as shown in the property curve f, increased from about 15° C. at the beginning to about 23° C. after 50 hours. The outdoor temperature, as shown in the property curve f, hardly changed, being about 12° C., and increased by the dehumidification, as shown in the property curve d of the temperature in the processed space 10.

In addition, when the processed space 10 was ventilated by an ordinary method, but not the method of the present invention, as shown in the property curve c of FIG. 2, the concentration of formaldehyde after 50 hours decreased to only 0.08 ppm.

FIG. 3 shows the test results about the removal of formaldehyde of a higher concentration than that of FIG. 2. The removal effect similar to the case of FIG. 2 is seen.

As shown in FIG. 3, the formaldehyde removal effect is superior at the time of 135˜145 minutes and 165˜190 minutes when the variation rate of the RH in the processed space 10 is high. That is, the effect without the dehumidification tends to remain without change or increase slightly. However, when the RH in the processed space 10 is lowered rapidly, the formaldehyde removal effect appears notably.

FIG. 4 shows a removal effect of toluene. The removal effect is extremely superior during 65˜100 minutes when the variation rate is high during the RH reduction time in the processed space 10. However, the removal effect of toluene hardly appears not only during 30˜50 minutes and 55˜65 minutes when the RH variation rate is small, but also during 50˜55 minutes when the variation rate is high during the increase time. In other words, these findings indicate that when the RH in the processed space 10 is decreased rapidly, toluene also demonstrates the superior removal effect.

### EMBODIMENT 2

Next, Embodiment 2 using a dry-type rotor dehumidifier with solid desiccant is described.

As shown in the explanatory drawing of FIG. 5, the dry-type rotor dehumidifier (total heat exchanger) is an apparatus to humidify and dehumidify - regenerate as simultaneous processes, wherein a rotor 26 comprising solid desiccant such as silicagel, zeolite, or others is arranged to alternately go round a dehumidification side 32 and a humidification and regeneration side 33 in the apparatus, and at the dehumidification side 32, the rotor 26 absorbs a moisture from air introduced and at the humidification and regeneration side 33, the water is radiated from the rotor 26 absorbing the moisture and dried. The apparatus may be called a total heat exchanger because receipting a sensible heat and latent heat of water accompanies in accordance with the absorption and radiation drying of the moisture.

Use of the dry-type rotor dehumidifier enables to make a humidifier 14 and a dehumidifier 15 function by single said apparatus. The intake air and exhaust air at the dehumidification side 32 and the humidification•regeneration side 33 are connected through ducts between the inside and outside of the processed space 10. The connection is switched by a switch valve according to each process for the humidification of the first process or dehumidification of the second process to carry out it similarly to said Embodiment 1.

That is, on the humidification process of the first process, water in the atmosphere supplied from the outdoor air or water from the tank is absorbed at the rotor 26 at the dehumidification 32 and the air of the processed space 10 introduced at the humidification•regeneration side 33 is passed through the wet rotor 26 for humidification and then radiated into the processed space 10 again. To assist the humidification under a vapor phase condition on the humidification process, a humidifier may be set at the step prior to the dehumidification side 32.

On the dehumidification of the second process, the air of the processed space 10 is introduced at the dehumidification side 32 and the moisture is absorbed at the rotor 26 for dehumidification, and radiated into the processed space 10 again. On the dehumidification process, the water molecules are absorbed on the surface of solid desiccant under a high humidity condition so preferentially that VOC cannot be captured by the solid desiccant easily. As the result, under a high humidity condition at the first stage on the dehumidification process, the VOC-removal effect of the solid desiccant is weak. As the dehumidification progresses and VOC hydrate complexes in the atmosphere dissociate to water and VOC and the humidity decreases furthermore, the absorption level of VOC to the solid desiccant increases. That is, to eliminate VOC by the solid desiccant, it is necessary to highly dry the surface of the solid desiccant for a strong dehumidification on the regeneration process.

Because the equilibrium with inside of the VOC impregnated material collapses in accordance with the reduction of humidity (water vapor pressure) in the processed space by the dehumidification, the levels of water and VOC hydrate complexes radiated from the inside of the VOC impregnated material increase to adjust for the equilibrium. That is, at the initial stage on the dehumidification process, the level of VOC hydrate complexes radiated from the VOC impregnated material is small and the VOC removal effect from the VOC impregnated material is weak.

Because of these two reasons, the VOC removal effect at the initial stage on the dehumidification process using solid desiccant is weak and its marked effect begins to appear at a time when the dehumidification of the processed space progresses to a certain extent or more. That is, maintaining the whole atmosphere in the processed space under a dry condition promotes to radiate VOC from the VOC impregnated material and moreover, the radiated VOC hydrate complexes dissociate to water and VOC. As such, VOC hydrate complexes in the impregnated material can be captured and collected effectively.

As for moisture and VOC hydrate complexes absorbed at the rotor 26, by warming the desiccant on the regeneration process, the moisture evaporates and the VOC hydrate complexes are decomposed and dehydrated and then exhausted from a regenerative outlet to the outside of the processed space.

Embodiment 2 is a case using single dry-type rotor dehumidifier. As described previously, because solid desiccant can't capture and collect VOC easily at a high humidity of the processed atmosphere, a strong dehumidifier is desired. It may be done to connect two dry-type rotor humidifiers in series and capture water molecules by the dehumidifier at the pre-step to make the processed atmosphere a dry condition and then capture and eliminate VOC by the dehumidifier at the post-step.

In Embodiment 2, even if the VOC absorbed at the rotor is dried at an ordinary temperature or a slightly higher temperature than an ordinary one, only water is radiated and VOC remain in the solid desiccant. Usually, it is necessary to radiate them through an atmosphere at a high temperature (for example, 150° C. or higher) at a certain time interval or with every a certain flow volume, and the desiccant deteriorates so severely by such high temperature that the rotor's life is short in comparison with the high cost. Accordingly, the following processes are considered.

That is, applying the difference between absorption of water and absorption of VOC hydrate complexes in solid desiccant, (1) a large amount of vapor-phase water are absorbed to form VOC hydrate complexes, by which water is replaced with and VOC is eliminated, and subsequently, (2) the drying is done through an atmosphere at a slightly higher temperature than an ordinary one. These processes enable to eliminate VOC without a high temperature and consequently suppress the deterioration of the desiccant.

Specifically, using a dehumidifier divided into a dehumidification side and regeneration side conventionally, it may be done to alternately operate for VOC removal of (1) and drying of (2) at the regeneration side, or to continuously operate as the regeneration side is subdivided into VOC removal for (1) and drying side for (2).

In Embodiment 2, both the humidification and dehumidification processes are conducted by dry-type rotor dehumidifier. However, the present invention is not limited to this and for the humidification of the first process, a humidifier for exclusive use may be set separately.

Although it was explained to humidify the inside of the processed space 10 to a vapor-phase high humidity within a range not reaching the saturation in the above embodiments, even in the saturation state, the present invention has no problem, except for the following two points. The first problem is that because saturated liquid-phase water must be dehumidified, it is necessary to increase the dehumidification volume of the dehumidifier or prolong the time of the dehumidification process. Another problem is dewing inside the processed space 10. Either of these problems doesn't reduce the action/effect of the present invention.

### INDUSTRIAL APPLICABILITY

Because a processing with a high temperature is absent, interior materials, installed objects or other don't deteriorate. And because vapor-phase water molecules infiltrate into VOC impregnated materials and VOC can be radiated to the atmosphere by force, VOC existing in VOC impregnated materials can be also eliminated.

What are claimed are:

1. A VOC removal method from VOC impregnated materials, comprising the first process to produce VOC hydrate complexes with VOC absorbed/impregnated at the inside of said VOC impregnated materials by humidifying a processed space wherein said VOC impregnated materials exist to a vapor-phase high humidity and then making vapor-phase water molecules infiltrate into said VOC impregnated materials; and promoting to radiate said VOC hydrate complexes produced in said VOC impregnated materials on said first process into said processed space.

2. A VOC removal method from VOC impregnated materials as defined in claim 1 wherein said VOC hydrate complexes radiated into said processed space dissociate to water and VOC by dehumidifying said processed space to lower the humidity.

3. A VOC removal method from VOC impregnated materials as defined in claim 2 wherein said processed space is dehumidified by liquid desiccant to lower the humidity and VOC are captured and collected.

4. A VOC removal method from VOC impregnated materials as defined in claim 2 wherein said processed space is dehumidified by solid desiccant to lower the humidity and VOC are captured and collected.

5. A VOC removal method from VOC impregnated materials as defined in claim 3 or 4 wherein the indoor relative humidity (RH) in the humidification on said first process is set at 60˜95%, higher than the outdoor humidity, and the RH in the dehumidification on the second process is set at 40% or less.

6. A VOC removal method from VOC impregnated materials as defined in claim 3 or 4 wherein in the humidification on said first process and the dehumidification on said second process, said processed space is warmed to make the temperature of the processed space within a temperature range of the original temperature of said processed space +30° C.

7. A VOC removal, method from VOC impregnated materials as defined in claim 3 or 4 wherein said first process and said second process are made one cycle and said cycle is repeated multiple times.
